(19) United States
(12) Patent Application Publication
(10) Pub. No.: US 2020/0097863 A1
(43) Pub. Date: Mar. 26, 2020

(54) VEHICLE MANAGEMENT SYSTEM

(71) Applicant: HONDA MOTOR CO., LTD., Tokyo (JP)

(72) Inventors: Shigenori Hiruta, Wako-shi (JP); Naoki Kato, Wako-shi (JP); Yuji Saito, Tokyo (JP); Hiroyuki Hayashi, Kawasaki-shi (JP)

(21) Appl. No.: 16/544,142

(22) Filed: Aug. 19, 2019

(30) Foreign Application Priority Data
Sep. 25, 2018 (JP) 2018-179037

(51) Int. Cl. G06Q 10/02; G06Q 10/06

(52) U.S. Cl. CPC G06Q 10/02; G06Q 30/0207; G06Q 10/0631

(57) ABSTRACT

A vehicle management system that manages a vehicle that is to be used by a plurality of users generates schedule information based on an action schedule of the next user following the current user, and outputs to the next user a suggestion of changing a return location where the current user terminates the use of the vehicle based on the generated schedule information of the next user.

### INCORPORATION BY REFERENCE

The present application claims priority under 35 U.S.C. § 119 to Japanese Patent Application No. 2018-179037 filed on Sep. 25, 2018. The content of the application is incorporated herein by reference in its entirety.

### BACKGROUND OF THE INVENTION

### Field of the Invention

The present invention relates to a vehicle management system that manages a vehicle that is to be used by a plurality of users.

### Description of the Related Art

A method of vehicle use such as car sharing is known that allows a single vehicle to be used by a plurality of users in sequence. For such a shared vehicle, a location of a station that is a place where the use of the vehicle is to be started and a location of another station that is a place where the vehicle is to be returned are usually determined in advance. However, it is sometimes deemed more convenient to flexibly determine such a start-of-use place and a return place of the vehicle in accordance with a user's action, etc.

For instance, Japanese Patent Laid-Open No. 2015-225368 describes a shared vehicle management system including a shared vehicle management device that manages a plurality of stations available for a shared vehicle. The shared vehicle management device determines, when the shared vehicle is to be parked at a station different from a scheduled return station, whether the different station is available, such as whether the different station is to be used by another shared vehicle. When the different station is determined to be available, the shared vehicle management device suggests changing the return station to the different station to the shared vehicle.

However, the above conventional system is designed in consideration of convenience to a user who currently uses the shared vehicle, so that returning the shared vehicle to the suggested return station would impair convenience to the next user, causing some problems. For instance, it may be necessitated to transfer the vehicle to a scheduled start-of-use station for the next use.

Accordingly, the conventional system has room for improvement in enhancing the convenience to the next user of the shared vehicle.

### SUMMARY OF THE INVENTION

In view of the above background, an object of the present invention is to improve, when a vehicle is to be used by a plurality of users in sequence, convenience to the next user who uses the vehicle sequentially to the current user.

According to an aspect of the present invention, a vehicle management system that manages a vehicle that is to be used by a plurality of users includes: a use management section that manages schedule-of-use information and a state of use of the vehicle; an action schedule acquiring section that acquires an action schedule of each of the plurality of users; and a suggesting section that outputs a suggestion of changing a return location, or a parking location, of the vehicle at termination of use of the vehicle to, among the plurality of users, a next user who uses the vehicle next after a current user, the suggesting section generating schedule information of the next user based on the action schedule of the next user, and outputting the suggestion based on the generated schedule information of the next user, the suggestion being referred to as a first suggestion.

According to another aspect of the present invention, a vehicle management system that manages a vehicle that is to be used by a plurality of users includes: a use management section that manages schedule-of-use information and a state of use of the vehicle; an action schedule acquiring section that acquires an action schedule of each of the plurality of users; and a suggesting section that outputs a suggestion of changing a return location, or a parking location, of the vehicle at termination of the use of the vehicle to, among the plurality of users, a current user who currently uses the vehicle, the suggesting section generating schedule information of, among the plurality of users, a next user who uses the vehicle next after the current user based on the action schedule of the next user, and outputting the suggestion based on the generated schedule information of the next user, the suggestion being referred to as a first suggestion.

In the other aspect of the present invention, the schedule information of the next user contains: a current location of the next user; information of a location of a scheduled spot to be visited during a period from a current time to a scheduled start-of-use time for start of the use of the vehicle; or information of a location of a spot to be visited during the use of the vehicle started from the scheduled start-of-use time.

In the other aspect of the present invention, the suggesting section: presents the suggestion to the next user; acquires the suggestion selected from the presented suggestion by the next user; and presents the suggestion selected by the next user to the current user.

In the other aspect of the present invention, the suggesting section further generates schedule information of the current user based on the action schedule of the current user, and outputs the suggestion based on both of the generated schedule information of the current user and the schedule information of the next user, the suggestion being referred to as a second suggestion.

In the other aspect of the present invention, the schedule information of the current user contains, about the current user: a current destination; information of a location of a scheduled spot to be visited or a scheduled travel route during a period from a current time to a scheduled termination-of-use time for termination of the use of the vehicle; or information of a location of a scheduled spot to be visited during a predetermined period of time after the scheduled termination-of-use time.

In the other aspect of the present invention, the vehicle management system further includes an incentive providing section that provides an incentive for agreement on the first suggestion to the current user.

In the other aspect of the present invention, the vehicle management system further includes an incentive providing section that provides to the current user an incentive for agreement on each of the first suggestion and the second suggestion, the incentive provided by the incentive providing section for the agreement on the first suggestion being larger than the incentive for the agreement on the second suggestion.

According to the present invention, it is possible to improve, when a vehicle is to be used by a plurality of users in sequence, convenience to the next user who uses the vehicle sequentially to the current user.

### BRIEF DESCRIPTION OF THE DRAWINGS

FIG. 1 shows a configuration of a vehicle management system according to an embodiment of the present invention;

FIG. 2 shows an example of a situation for the vehicle management system shown in FIG. 1 to suggest changing a return location;

FIG. 3 shows a configuration of a use management server in the vehicle management system shown in FIG. 1;

FIG. 4 shows a configuration of an in-vehicle system in the vehicle management system shown in FIG. 1;

FIG. 5 shows an example of a user DB held in the use management server shown in FIG. 2;

FIG. 6 shows an example of a use information DB held in the use management server shown in FIG. 2;

FIG. 7 shows an example of a schedule DB held in the use management server shown in FIG. 2;

FIG. 8 shows an example of a display screen image of a suggestion list appearing on a mobile terminal of a user in the vehicle management system shown in FIG. 1;

FIG. 9 shows an example of a display screen image of a suggestion list appearing on a display of a use management device in the vehicle management system shown in FIG. 1; and

FIG. 10 is a flowchart showing a process of suggesting changing the return location being performed by the use management server in the vehicle management system shown in FIG. 1.

### DETAILED DESCRIPTION OF THE PREFERRED EMBODIMENT

An embodiment of the present invention will be described below with reference to drawings.

[1. Configuration of Vehicle Management system 100]

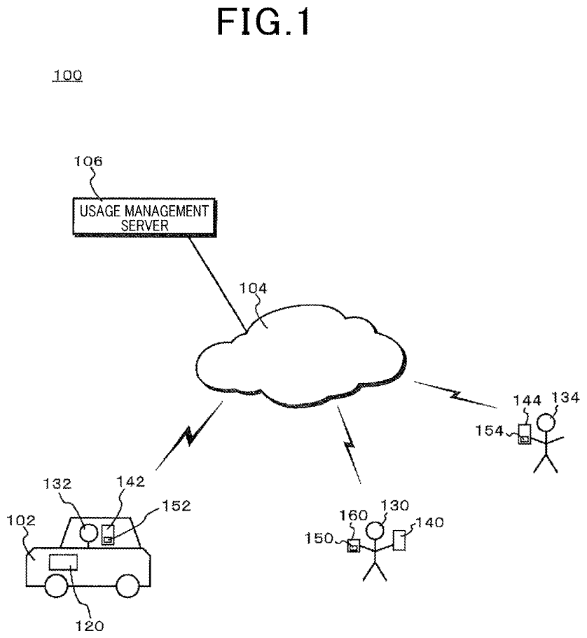

FIG. 1 shows a configuration of a vehicle management system according to the present invention. A vehicle management system 100 includes a vehicle 102 and a use management server 106 connected to the vehicle 102 for communication through a network 104. In the present embodiment, the network 104 is, for instance, the Internet connectable through a public line, etc.

The vehicle 102 is, for instance, a vehicle intended for car sharing, which is to be used by a plurality of users in sequence. In the present embodiment, the vehicle 102 is to be used by users 130, 132, 134. These users include an owner of the vehicle 102, who offers the vehicle 102 for car sharing. Here, the user 130 is the owner of the vehicle 102.

The vehicle 102 includes an in-vehicle system 120. The use management server 106 manages the use of the vehicle 102 among the plurality of users in conjunction with the in-vehicle system 120 in the vehicle 102.

The use management server 106 assigns unique user ID and electronic key basic information to each person who wishes to use the vehicle 102, and stores the ID and information as user information in a user DB 352 (described later) along with an e-mail address of a mobile terminal of the person who wishes to use. The use management server 106 thus registers the person who wishes to use as a user. Here, the electronic key basic information contains authentication information that is to be used by the vehicle 102 for authentication of the electronic key. It should be noted that the mobile terminal in the present embodiment is, for instance, a smartphone.

In addition, the use management server 106 receives a use reservation of the vehicle 102 from a user and sets a reserved time range for use. The use management server 106 generates schedule-of-use information that includes a reservation ID for identifying the use reservation, the set reserved time range for use, and the user ID of the user. Specifically, the use management server 106 adds information that indicates a scheduled start location (a start-of-use location where the use of the vehicle 102 is to be started) and information that indicates a scheduled return location (a location where the vehicle 102 is to be returned) to the schedule-of-use information. In this regard, the scheduled start location and the scheduled return location may be determined by the use management server 106 in accordance with a desire of the user. The use management server 106 then stores the generated schedule-of-use information in an information DB 354 (described later).

It should be noted that the use management server 106 also stores a schedule of use by the user who is the owner of the vehicle 102 as a user, as the schedule-of-use information in the use information DB 354. For instance, information that indicates a time range that has been set aside by the owner, for instance, for the use of the vehicle 102 by himself/herself or maintenance of the vehicle 102 and is not available for use reservation by the other users (e.g., “reservation-prohibited period of time”) is also managed as the schedule-of-use information by the use management server 106 in the present embodiment. [0017]

When storing the schedule-of-use information for each of the user 132, etc., except the user 130 (the owner), in the use information DB 354, the use management server 106 generates an electronic key based on the electronic key basic information generated for the user, the electronic key including a reservation ID for the schedule-of-use information and information of the reserved time range for use. The use management server 106 then sends the generated electronic key to a mobile terminal of the user.

The “electronic key” and “key code” hereafter mean the same thing. In particular, when the key code, which is an embodiment of the electronic key, is explicitly described, the term “key code” is used alone or with the term “electronic key.”

In the present embodiment, for the use of the vehicle 102, the users 132, 134 use key codes 152, 154, each of which includes the electronic key basic information, the reserved time range information, and the reservation ID, downloaded from the use management server 106 to mobile terminals 142, 144, respectively. Meanwhile, the user 130, who is the owner of the vehicle 102, uses a key code 150 stored in an FOB key 160 for the use of the vehicle 102.

The in-vehicle system 120 in the vehicle 102 authenticates the key code 152 or the like sent by the user 132 or the like, except the owner, from the mobile terminal 142 or the like based on the electronic key basic information contained in the key code 152 or the like, and acquires information of the reserved time range for use contained in the key code 152 or the like. When the current time is within the acquired reserved time range for use, the in-vehicle system 120 accepts a door-unlocking request and a vehicle-starting request to the vehicle 102 using the key code 152 or the like, causing these operations.

Afterward, the user 132 or the like, except the owner, parks the vehicle 102 at the scheduled return location at the termination of the use of the vehicle 102 for the reserved time range for use for him/her. The user 132 or the like then takes a procedure for the termination of the use of the vehicle 102 in the current reserved time range for use using the mobile terminal 142 or the like by sending a termination-of-use notification containing his/her user ID to the use management server 106 through, for instance, a browser that accesses a Web site provided by the use management server 106.

The user 132 or the like uses the vehicle 102 within his/her reserved time range for use, which is stored in the use information DB 354 in the use management server 106, in the above manner. It should be noted that the user 130, who is the owner, uses the vehicle 102 under his/her control within his/her reserved time range for use using the FOB key 160.

In the instance shown in FIG. 1, the user 132, who is seated in the vehicle 102, is the current user and the next user who is to use the vehicle 102 next after the user 132 is the user 130. However, this is merely an example and thus each of the current user and the next user may be any one of the users including the user 130, or the owner.

In the present embodiment, the use management server 106 also acquires respective action schedules of the user 130, etc. from, for instance, the mobile terminal 140 carried by the user 130, etc. and stores the action schedules in a schedule DB 356 (described later). Then, during the use of the vehicle 102 by the current user 132, the use management server 106 suggests to the current user 132 changing the scheduled return location at a predetermined timing before the scheduled termination-of-use time for the current use. The predetermined timing may be, for instance, time reached after the elapse of a predetermined amount of time since a scheduled start-of-use time or the actual start-of-use time of the current user.

Specifically, when the predetermined timing comes, the use management server 106 generates respective schedule information of the current user 132 and the next user 130 based on the respective action schedules of the current user 132 and the next user 130 stored in the schedule DB 356. The schedule information is information provided by adding additional information, such as current location information of the corresponding user, acquired from the user's mobile terminal or the in-vehicle system 120 to the acquired corresponding action schedule.

The use management server 106 then suggests changing the scheduled return location to the user 132 (the current user) based on the schedule information of the user 130 (the next user). Specifically, the use management server 106 selects a location convenient to the next user 130 as a candidate to be changed for the return location based on the schedule information of the next user 130, and generates a suggestion of changing the return location (type 1 suggestion) that suggests changing the scheduled return location to the selected location.

In addition, based on both of the schedule information of the user 132 (the current user) and the schedule information of the user 130 (the next user), the use management server 106 selects a location convenient to the next user 130 even in consideration of the convenience to the current user 132 as a candidate to be changed for the return location, and generates a suggestion of changing the return location (type 2 suggestion) that suggests changing the scheduled return location to the selected location.

Subsequently, the use management server 106 first presents a suggestion list that includes the generated type 1 and type 2 suggestions to the next user 130, and acquires suggestions selected from the suggestion list by the next user 130. The use management server 106 next presents a list of the acquired suggestions selected by the next user 130 to the current user 132, and acquires one of the suggestions selected from the list by the current user 132 as a single suggestion agreed on by both of the current user 132 and the next user 130.

It should be noted that such presentation and acquirement are performed relative to the next user 130 through the mobile terminal 140 of the user 130, while being performed relative to the current user 132 through the in-vehicle system 120.

Further, when the vehicle 102, which is used by the current user 132, arrives at the return location indicated by the single suggestion agreed on by both users at the termination of use of the vehicle 102, the use management server 106 provides to the current user 132 an incentive in accordance with the type of the single suggestion agreed on by both users. The incentive in the present embodiment may be so-called “point” for, for instance, fee discount, etc. It should be noted that when the current user is the user 130, who is the owner of the vehicle 102, the incentive is not provided.

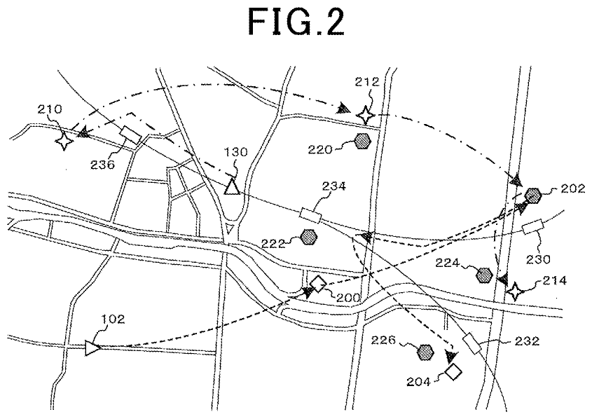

FIG. 2 shows an example of a situation for the vehicle management system 100 to suggest changing the return location. In FIG. 2, a traffic line that shows a travel schedule of the current user 132 is represented by a dashed line and a traffic line that shows a travel schedule of the next user 130 is represented by a chain line. In FIG. 2, the user 132 (the current user) travels right in the figure toward a next destination 200 by the vehicle 102, which is represented by a triangle in the figure. The use management server 106 acquires the current location of the vehicle 102 from the vehicle 102.

After travelling from the current location to the destination 200, the user 132 travels to a station 202, which is a currently scheduled return location, for the termination of the use of the vehicle 102. The user 132 is then scheduled to travel from a nearest train station 230 of the station 202 to a destination 204 around a train station 232 by train. The use management server 106 estimates such an intended travel of the user 132 from the schedule information generated based on the action schedule acquired from the mobile terminal 142 of the user 132. A means of transportation for travelling from the station 202 to the destination 204 used by the user 132 may be estimated to be train by, for instance, the use management server 106 based on map information, etc.

Meanwhile, the current location of the user 130 (the next user), who is currently travelling by train, is almost the halfway point between a train station 234 and a train station 236. The use management server 106 acquires the current location of the user 130 from, for instance, the mobile terminal 140 of the user 130. The user 130 then gets off the train at the train station 236 and travels to a destination 210 and, subsequently, travels to a destination 212 (e.g., restaurant a) by bus. The user 130 further travels to the station 202 by bus and then starts the use of the vehicle 102 at the station 202 for travel to a destination 214 (e.g., hotel b) according to the schedule.

The use management server 106 estimates such an intended travel of the user 130 from the schedule information generated based on the action schedule acquired from the mobile terminal 140 of the user 130. A means of transportation for travelling from the destination 210 to destination 212 and travelling from the destination 212 to the station 202 may be estimated to be bus by, for instance, the use management server 106 based on the map information, etc. in the same manner as described above.

Next, based on the generated schedule information of the user 130 (the next user), the use management server 106 searches, for instance, map information 350 (described later) for the nearest station of the destination 212, where the user 130 visits immediately before travelling to the station 202, thereby discovering a station 220. Further, based on the schedule information of the user 130, the use management server 106 searches the map information 350 for the nearest station of the destination 214, where the user 130 travels immediately after starting the use of the vehicle 102, thereby discovering a station 224. The use management server 106 then determines respective suggestions of changing the return location to the stations 220 and 224 as suggestions of changing the return location based on the schedule information of the next user 130 (the type 1 suggestions).

In addition, based on the schedule information of the next user 130 and the schedule information of the current user 132, the use management server 106 finds out that, for instance, the current user 132 stays at the destination 200 during substantially the same time range as the next user 130 stays at the destination 212. Accordingly, the use management server 106 searches, for instance, the map information 350 for a station present within a predetermined distance from both of the destination 212 and the destination 200, thereby discovering a station 222.

In addition, based on the schedule information of the next user 130 and the schedule information of the current user 132, the use management server 106 finds out that, for instance, the next user 130 stays at the destination 214 after starting the use of the vehicle 102 during substantially the same time range as the current user 132 stays at the destination 204 after terminating the use of the vehicle 102. Accordingly, the use management server 106 searches, for instance, the map information 350 for a station present within a predetermined distance from both of the destination 204 and the destination 214, thereby discovering a station 226.

The use management server 106 then determines a suggestion of changing the return location to each of the discovered stations 222 and 226 as a suggestion of changing the return location based on both of the schedule information of the current user 132 and the schedule information of the next user 130 (the type 2 suggestion).

Subsequently, the use management server 106 sends a suggestion list that contains the type 1 and type 2 suggestions to the mobile terminal 140 of the next user 130 for presentation to the user 130. The user 130 selects agreeable suggestions from the presented suggestion list and sends the selected suggestions to the use management server 106. The use management server 106 receives the selected suggestions and sends a list of the suggestions selected by the next user 130 to the user 132 through the in-vehicle system 120 in the vehicle 102.

When the current user 132 selects a single agreeable suggestion from the presented suggestion list, the selected suggestion is sent to the use management server 106 through the in-vehicle system 120. The use management server 106 receives the selected suggestion and identifies the received suggestion as a single suggestion agreed on by both of the current user 132 and the next user 130. The use management server 106 then informs the current user 132 and the next user 130 of the identified suggestion through the in-vehicle system 120 and the mobile terminal 140, respectively. Here, according to the identified (agreed) suggestion, the return location is to be changed to the station 220.

The use management server 106 then detects that the vehicle 102 has arrived at the station 220 indicated by the identified suggestion with reference to the current location of the vehicle 102 acquired from the vehicle 102. In response to the detection of the arrival, the use management server 106 adds, after waiting for the procedure for the termination of the use to be taken by the current user 132, an incentive (e.g., points to be acquired) based on the present agreement on the suggestion to incentive information (e.g., held points) in the user information of the user 132 stored in the user DB 352, thereby providing the incentive to the user 132.

Here, an incentive amount for the agreement on the suggestion is determined in advance for each of the type 1 suggestion and the type 2 suggestion, and an incentive for the agreement on the type 1 suggestion is defined to be a larger value with respect to an incentive for the agreement on the type 2 suggestion.

The vehicle management system 100 with the above configuration suggests changing the return location for the current user, or the start-of-use location for the next user, based on the action schedule of the next user, etc. The vehicle management system 100 thus allows the next user to start the use of the vehicle 102 near a travel route according to his/her schedule with an enhanced convenience to the next user.

In addition, the vehicle management system 100 allows such a suggestion to be accepted (approved) based on the agreement by both of the current user and the next user, thereby enhancing the convenience to the next user with the preference of the current user being reflected. In addition, the vehicle management system 100 provides the incentive to the current user who accepts the suggestion, thereby motivating the current user to accept the suggestion.

Further, the vehicle management system 100 provides the incentive for the type 1 suggestion defined to be larger than the incentive for the type 2 suggestion, thereby encouraging the current user to accept a suggestion that provides a higher convenience to the next user. [2. Configuration of Use Management Server 106]

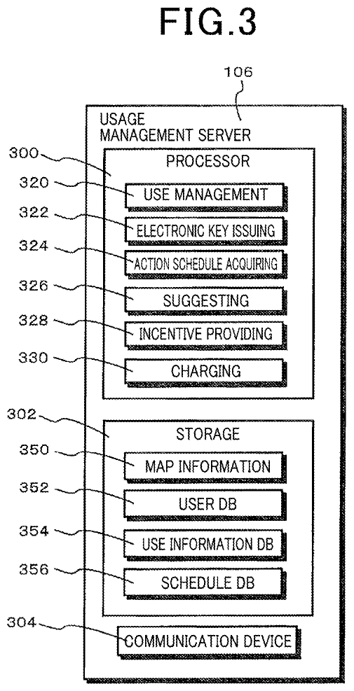

FIG. 3 shows a configuration of the use management server 106. The use management server 106 includes a processor 300, a storage 302, and a communication device 304. The communication device 304 is a transmitter/receiver capable of wire communication or wireless communication for connecting the processor 300 to the network 104.

The storage 302, which is, for instance, a hard disk device, stores the map information 350, the user data base (user DB) 352, the use information database (use information DB) 354, and the schedule database (schedule DB) 356. In the map information 350, information is stored that indicates predetermined locations of stations (e.g., long-term parking lots) where the vehicle 102 can be parked for the delivery of the vehicle 102 between the users. The user DB 352, the use information DB 354, and the schedule DB 356 will be described later.

The processor 300 is, for instance, a computer including a processor such as CPU (Central Processing Unit). The processor 300 may include programmed ROM (Read Only Memory), RAM (Random Access Memory) for temporarily storing data, etc. The processor 300 further includes, as functional elements or functional units, a use management section 320, an electronic key issuing section 322, an action schedule acquiring section 324, a suggesting section 326, an incentive providing section 328, and a charging section 330.

These functional elements of the processor 300 are implemented by, for instance, the execution of a program by the processor 300, or the computer. It should be noted that such a computer program may be stored in any computer-readable storage medium. Alternatively, all or part of the functional elements of the processor 300 may each be in the form of a hardware including one or more electronic circuit components.

[2.1 Use Management Section 320]

The use management section 320 receives registration information sent from a mobile terminal of a person who wishes to use. The person who wishes to use may access, for instance, the web site provided by the use management server 106 to send the registration information from the mobile terminal to the use management server 106. The registration information contains the name of the person who wishes to use and terminal information for accessing the mobile terminal of the person who wishes to use. Based on the registration information, the use management section 320 generates unique user ID and electronic key basic information for the person who wishes to use, and generates user information including the generated user ID and the electronic key basic information, user terminal information consisting of the terminal information contained in the registration information, and incentive information. Here, the incentive information indicates an accumulated value of an incentive (in the present embodiment, points as described above), i.e., held points, provided as a result of agreement on the suggestion of changing the return location.

The use management section 320 then stores the generated user information in the user DB 352, thereby registering the person who wished to use as a user. Hereafter, a user refers to the owner of the vehicle 102 and a user registered as described above. It should be noted that the use management section 320 assigns the user 130, who is the owner of the vehicle 102, with a user ID capable of identification of the owner in advance, and stores the user ID as the user information in the user DB 352 along with the user terminal information of the owner, thereby registering the user 130, or the owner.

The use management section 320 also manages the schedule-of-use information and state of use of the vehicle 102 per user. Specifically, the use management section 320 receives use reservation information sent from the mobile terminal of each user (e.g., the mobile terminal 142 of the user 132). The use reservation information contains the user ID of the user (sender), a desired time range for use, a desired start location, and a desired return location. Here, the start location refers to a location of the vehicle 102 at the start of use and the return location refers to a location of the vehicle 102 at the termination of use.

When the desired time range for use contained in the received use reservation information does not overlap the reserved time range for use having already been stored in the use information DB 354, the use management section 320 sets the time range indicated by the desired time range for use as a reserved time range for use. In addition, when the desired start location and the desired return location are acceptable, the use management section 320 sets the desired start location and the desired return location as a scheduled start location and a scheduled return location. In addition, the use management section 320 generates a reservation ID for identifying the reservation of use for the set reserved time range for use.

Here, the user may select each of the desired start location and the desired return location from the predetermined locations. In addition, the use management section 320 may determine whether the desired start location and the desired return location are acceptable based on, for instance, whether the desired start location and return location are to be occupied by other vehicles at the start of the use and the termination of the use of the vehicle 102, respectively.

The use management section 320 then generates the schedule-of-use information that contains the generated reservation ID, the user ID of the user who has reserved the use of the vehicle 102, the set reserved time range for use, the scheduled start location, and the scheduled return location. In addition, the use management section 320 generates state-of-use information that indicates the state of use of the vehicle 102 corresponding to the generated schedule-of-use information. The state-of-use information contains a status that indicates the status of the use of the vehicle 102 corresponding to the schedule-of-use information and suggestion agreement information that indicates the type of a suggestion agreed on by the user in response to a later-described change-of-return suggestion. An initial state of the suggestion agreement information is a blank state where nothing is set.

The use management section 320 then stores use management information, in which the generated schedule-of-use information and state-of-use information are associated with each other, as one record in the use information DB 354. In addition, when storing the use management information in the use information DB 354, the use management section 320 sends that effect and the reservation ID of the stored use management information to the electronic key issuing section 322.

Here, the “status” refers to the status of the use of the vehicle 102 during the reserved time range for use indicated by the schedule-of-use information. The status is set to one of “NOT STARTED”, which means that the use of the vehicle 102 has not been started, “STARTED”, which means that the use has been started, and “TERMINATED”, which means the use has been terminated. In generating the state-of-use information, the use management section 320 sets the status of the state-of-use information to be generated to “NOT STARTED.”

Further, when both of the current user and the next user agree on the suggestion of changing the return location, the suggesting section 326 (described later) stores the type of the agreed suggestion (i.e., “1” or “2”) in the “suggestion agreement information.” In addition, in response to the agreement on the suggestion, the suggesting section 326 changes the scheduled return location contained in the corresponding schedule-of-use information to the return location indicated by the agreed suggestion. It should be noted the type of the agreed suggestion is stored after the status is set to “TERMINATED.” Thus, when the status is “TERMINATED” but the suggestion agreement information is blank, any one of suggestions for the corresponding use of the vehicle 102 is determined not to be agreed on.

Further, for each use management information stored in the use information DB 354, the use management section 320 updates the status contained in the corresponding use management information in response to the start and termination of the use of the vehicle 102. Specifically, in response to receiving the start-of-use notification from the vehicle 102 and receiving the termination-of-use notification from the mobile terminal of the current user, the use management section 320 sets the status to “STARTED” and “TERMINATED”, respectively. When setting the status to “STARTED”, the use management section 320 sends a notification indicating that the use has been started to the suggesting section 326. Meanwhile, when setting to the status to “TERMINATED”, the use management section 320 sends a notification indicating the use has been terminated to the suggesting section 326, the incentive providing section 328, and the charging section 330.

[2.2 User DB 352]

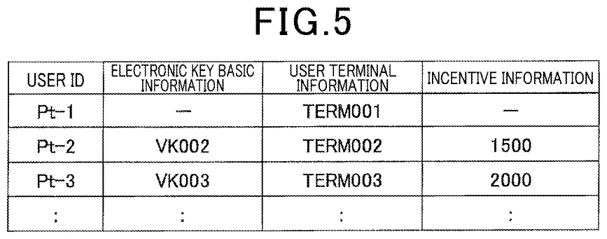

FIG. 5 shows an example of the user DB 352 generated by the use management section 320. In the example as shown, the user DB 352 is in a table form, containing the user ID, the electronic key basic information, the user terminal information, and the incentive information in order from a left column in the figure. As described above, in the present embodiment, the incentive is in the form of “point” that determines the discount rate of, for instance, the usage fee for the vehicle 102, and is provided by the later-described incentive providing section 328. The point may determine the grade of a prize to be exchanged. The incentive information indicates the amount of the incentive currently provided to the user, which are so-called held points.

Second row and subsequent rows thereto in the figure each indicate the corresponding user information. The second row indicates the user ID of the user 130 (the owner of the vehicle 102), i.e., Pt-1, and the user terminal information, i.e., TERM001. Here, since the user 130, or the owner, uses the FOB key 160 for the use of the vehicle 102, no electronic key basic information is indicated. In addition, since the user 130 is the owner of the vehicle 102, his or her held points usable for the discount of the usage fee for the vehicle 102, etc. are not indicated.

The third and fourth rows in the table in the figure indicate the user IDs of the users 132, 134, i.e., Pt-2, Pt-3, the electronic key basic information, i.e., VK002, VK003, the user terminal information, i.e., TERM002, TERM003, and the current held points 1500, 2000, respectively.

[2.3 Use Information DB 354]

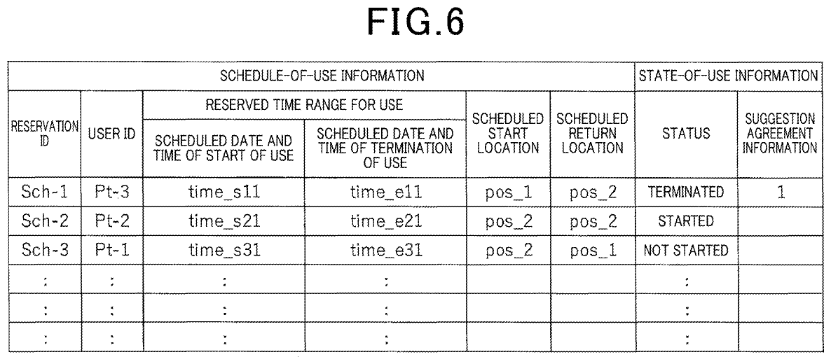

The use information DB 354 includes one piece or a plurality of pieces of use management information. FIG. 6 shows an example of the use information DB 354. In the example as shown, the use information DB 354 is in a table form, indicating respective pieces of use management information in rows except a title row. Each piece of use management information includes the schedule-of-use information and the state-of-use information. The schedule-of-use information includes the reservation ID, the user ID, the reserved time range for use, the scheduled start location, and the scheduled return location in order from a left column in the figure. The state-of-use information includes the status and the suggestion agreement information in order from a left column in the figure. Here, the reserved time range for use includes start time and ending time defining the reserved time range for use, i.e., scheduled date and time of start of use and scheduled date and time of termination of use.

The fourth to sixth rows in the table in the figure indicate the pieces of use management information with reservation IDs, Sch-1, Sch-2, Sch-3, respectively. It should be noted that the pieces of use management information in the example of the use information DB 354 in the figure are sorted in order of time of the reserved time range for use contained in each piece of use management information.

The piece of use management information in the fourth row indicates that the user 134 with a user ID of Pt-3 has “terminated” the use of the vehicle (see “Status” column, the fourth row) and the type “1” suggestion of changing the return location has been agreed on (see “Suggestion Agreement Information” column, the fourth row). Meanwhile, the piece of use management information in the fifth row indicates the user 132 with the user ID of Pt-2 has “started” the use of the vehicle after the user 134 indicated by the piece of use management information in the fourth row terminated the use of the vehicle (see “Status” column, the fifth row). Thus, it is found that the current user is the user 132. In addition, since the fifth row in the “Suggestion Agreement Information” is blank, it is found that no suggestion of changing return has been presented to the user 132 or that the presented suggestion has not yet been agreed on.

Meanwhile, the piece of use management information in the sixth row indicates that user 130 with the user ID of Pt-1 has “not started” the use of the vehicle after the use of the vehicle by the user 132 indicated by the piece of use management information in the fifth row (see “Status” column, the sixth row). Thus, it is found that the next user is the user 130.

[2.4 Electronic Key Issuing Section 322]

In response to being notified that the use management information is stored and receiving the reservation ID of the stored use management information from the use management section 320, the electronic key issuing section 322 generates the electronic key for the use of the vehicle 102 related to this use management information and sends it to the corresponding user.

Specifically, referring to the use management information with the received reservation ID, the electronic key issuing section 322 extracts the user ID and the reserved time range for use. In addition, the electronic key issuing section 322 acquires, when the extracted user ID does not identify the owner of the vehicle 102, or the user 130, the electronic key basic information and the user terminal information associated with the extracted user ID with reference to the user DB 352. The electronic key issuing section 322 then generates the electronic key containing the extracted reserved ID and reserved time range for use using the acquired electronic key basic information. The electronic key issuing section 322 also sends the generated key code to the mobile terminal of the user using the acquired user terminal information.

Thus, electronic keys 152, 154, each of which contains the reservation ID and the reserved time range for use of the corresponding use reservation information, are stored in, for instance, the mobile terminals 142, 144 of the users 132, 134 who have made the reservations for use, respectively.

[2.5 Action Schedule Acquiring Section 324]

The action schedule acquiring section 324 acquires the action schedule of each user registered in the user DB 352 and stores it in the schedule DB 356. Here, the action schedule of each user acquired by the action schedule acquiring section 324 contains information that specifies a location of a scheduled destination for each user and information of a scheduled arrival time at the destination.

For instance, the action schedule acquiring section 324 acquires the action schedule of the user 130 or the like from the mobile terminal 140 or the like of the user 130 or the like. Here, in the mobile terminal 140 or the like of the user 130 or the like, for instance, the user 130 or the like has inputted his/her own action schedule. A known schedule management application software executable by a mobile terminal such as a smartphone may be used to input the action schedule. Meanwhile, to allow the action schedule acquiring section 324 to acquire the action schedule from the mobile terminal 140 or the like, an application software may have been executed by the mobile terminal 140 or the like that is configured to, for instance, send information of the action schedule in response to a request from the use management server 106.

[2.6 Schedule DB 356]

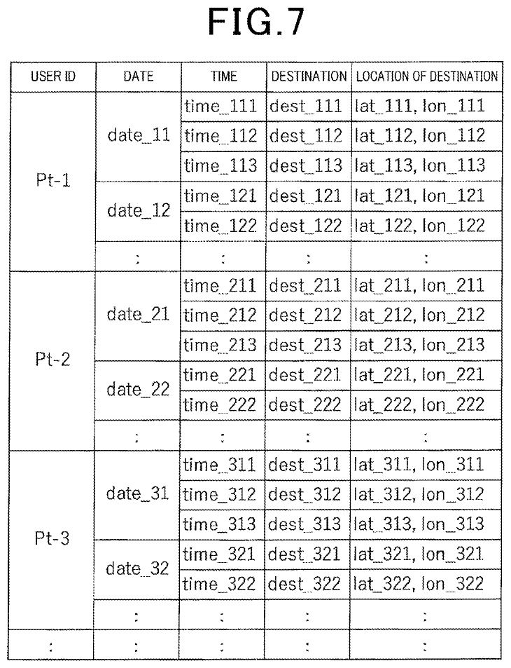

The schedule DB 356 includes action schedule information of each user. FIG. 7 shows an example of the schedule DB 356. In the example as shown, the schedule DB 356 is in a table form, including user ID, date, time, destination, and location of destination in order from a left column in the figure. The location of destination may include, for instance, latitude and longitude of the destination, which is calculated from the place name, building name, train station name, store name, or the like shown at the destination with reference to the map information 350 stored in the storage 302.

[2.7 Suggesting Section 326]

The suggesting section 326 outputs to the current user who currently uses the vehicle 102 a suggestion of changing the return location, or the location where the vehicle 102 is to be parked at the termination of use. Specifically, in response to receiving a notification indicating that the use of the vehicle 102 has been started from the use management section 320, the suggesting section 326 identifies the use management information related to the use of the vehicle 102 having been started with reference to the use information DB 354, identifying the scheduled termination-of-use time for the current use.

The suggesting section 326 then waits for the predetermined timing for presenting the suggestion of changing the return location to come based on the identified scheduled termination-of-use time. The predetermined timing may be, for instance, time earlier than the scheduled termination-of-use time by a predetermined amount of time.

In response to the predetermined timing coming, the suggesting section 326 identifies the current user and the next user of the vehicle 102 with reference to the use information DB 354. Then, referring to the schedule DB 356, etc., the suggesting section 326 generates, based on the scheduled action of each of the identified current user and next user, the schedule information of each of the current user and the next user.

Here, the schedule information generated about the next user contains, about the next user, the current location, information of a location of a spot to be visited during a period from the current time to the scheduled start-of-use time of the vehicle 102, and/or information of a location of a spot to be visited by the vehicle 102, which starts to be used from the scheduled start-of-use time.

Meanwhile, the schedule information generated about the current user contains, about the current user, the current destination of travel by the vehicle 102, information of a location of a spot to be visited or a scheduled travel route by the vehicle 102 during a period from the current time to the scheduled termination-of-use time, and/or information of a location of a spot to be visited during a predetermined period of time from the scheduled termination-of-use time.

Specifically, the suggesting section 326, for instance, acquires the current location of the next user from a mobile terminal of the next user and adds it to the acquired action schedule of the next user, thereby generating the schedule information of the next user. Meanwhile, the suggesting section 326, for instance, acquires destination information, route information, etc. that are currently set in a navigation device 410 in the vehicle 102 and adds them to the acquired action schedule of the current user, thereby generating the schedule information of the current user.

The suggesting section 326 then outputs a suggestion of changing the return location of the vehicle 102 to the current user based on the generated schedule information. Specifically, based on the generated schedule information of the next user, the suggesting section 326 outputs a first suggestion, which is a suggestion of changing the return location in consideration of the convenience to the next user. In addition, based on both of the schedule information generated about the current user and schedule information of the next user, the suggesting section 326 outputs a second suggestion, which is a suggestion of changing the return location in consideration of the convenience to the current user in addition to the convenience to the next user. Hereafter, the first suggestion is referred to as “type 1 suggestion” and the second suggestion as “type 2 suggestion.”

Specifically, based on the schedule information generated about the next user, the suggesting section 326, for instance, estimates a location of a spot to be visited by the next user, etc. during a period from time earlier than the scheduled termination-of-use time of the current user by a predetermined amount of time to time later than the same by a predetermined amount of time. Then, referring to the map information 350 stored in the storage 302, the suggesting section 326 locates a candidate for the return location in the vicinity of the estimated location (e.g., within a predetermined distance range from this location). The suggesting section 326 then generates a suggestion containing each located candidate for the return location. Such a suggestion, which is based on the schedule information generated about the next user, is referred to as the type 1 suggestion.

In addition, based on both of the schedule information generated about the next user and the schedule information generated about the current user, the suggesting section 326 generates the type 2 suggestion. Specifically, based on the schedule information generated about the current user and schedule information of the next user, the suggesting section 326, for instance, generates a traffic line of the current user and a traffic line of the next user on the map. In addition, the suggesting section 326 identifies time when these traffic lines become close to each other at a predetermined distance or less between the time earlier than the scheduled termination-of-use time for the current user by the predetermined amount of time and the time later than the same by the predetermined amount of time. The suggesting section 326 then locates in the map information 350 a candidate for the return location within a range reachable in a predetermined time period from both of the location of the current user and the location of the next user at each identified time. Here, such a range may be calculated with the proviso that the transportation usable by the next user is, for instance, by foot, bus, and/or train. The suggesting section 326 then generates a suggestion containing each located candidate for the return location as the type 2 suggestion.

It should be noted that the above method of generating a suggestion of changing the return location is merely exemplary and by no means limits the present invention. The type 1 suggestion may be generated by any method capable of generation based on the schedule information generated about the next user irrespective of the schedule information generated about the current user. For instance, based on the schedule information generated about the next user, the suggesting section 326 may locate respective locations of some of a bus stop, a train station, etc. on the traffic line where the next user is supposed to stay for a predetermined period of time in addition to the destination set in the action schedule, and generate a suggestion containing a candidate for the return location in the vicinity of each location.

Meanwhile, the type 2 suggestion may be generated by any method capable of generation based on both of the schedule information generated about the next user and the schedule information generated about the current user. For instance, the suggesting section 326 may locate respective closest locations on two traffic lines of the next user and the current user in a three-dimensional space, which is defined by adding a time axis representing time to a two-dimensional plane representing locations on the map. Based on the located locations on the traffic lines, the suggesting section 326 may search the map for a location of a candidate for the return location within a range reachable for the current user and the next user within a predetermined period of time.

Further, the suggesting section 326 does not necessarily generate both of the type 1 suggestion and the type 2 suggestion. The suggesting section 326 may be either one of the type 1 suggestion or the type 2 suggestion as a result of trying to generate a suggestion in accordance with predetermined conditions.

Next, the suggesting section 326 determines one of the generated suggestions based on the agreement by both of the current user and the next user. Specifically, the suggesting section 326 first presents a suggestion list containing the generated type 1 and type 2 suggestions to the next user. Such presentation is enabled by, for instance, sending the suggestion list to the mobile terminal of the next user. In response, the next user selects an agreeable suggestion from the received suggestion list and reply it using the mobile terminal.

Next, the suggesting section 326 presents a list containing the replied suggestion, which is selected from the presented suggestion list by the next user, to the current user. The suggesting section 326 then acquires, from among the suggestions presented to the current user, a single suggestion selected by the current user and identifies this acquired suggestion as a single suggestion agreed on by both. Such presentation to the current user and acquirement of the suggestion selected by the current user are enabled through the in-vehicle system 120 in the vehicle 102. When identifying the single suggestion agreed by both, the suggesting section 326 sends that effect and the identified agreed suggestion to the mobile terminal of the next user and the vehicle 102 for notification to the next user and the current user.

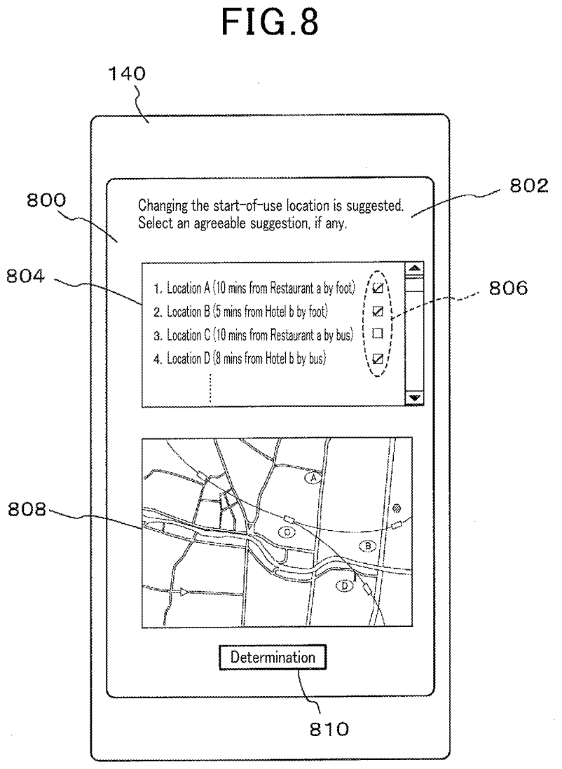

FIG. 8 shows an example of a display screen image of the sent suggestion list appearing on, for instance, the mobile terminal 140 of the user 130 (next user). A message 802 appears on a screen 800 of the mobile terminal 140 at an upper portion thereof in the figure, indicating “Changing the start-of-use location is suggested. Select an agreeable suggestion, if any.” Here, the suggestion of changing the return location is expressed by “changing the start-of-use location”, because the return location for the current user means the start-of-use location for the next user.

In addition, on the screen 800, the received suggestion list appears in a text box 804, displaying candidates for the return location, i.e., locations A, B, C, D, in respective rows. As shown in the figure, travel times from a scheduled spot to be visited by the next user to the respective candidates for the return location may be displayed. A check box 806 is provided at a right end of each row. The next user checks the check box in the row corresponding to an agreeable location to be changed for the start-of-use location, if any.

A map image 808 appears on the screen 800 below the text box 804. In the map image 808, a location of a candidate for the return location is represented by an oval icon. For instance, as the next user touches any one of the rows in the text box 804, the location of the corresponding candidate for the return location in the map image 808 is highlighted.

When the next user checks the check box 806 corresponding to the agreeable location and presses a “Determination” button 810 displayed at a lower portion of the screen 800, the candidates for the return location selected by the next user, i.e., type 1 and/or type 2 suggestion, is sent to the use management server 106.

The suggesting section 326 receives and acquires the suggestion selected by the next user. The suggesting section 326 then sends a suggestion list indicating the type 1 and/or type 2 suggestion selected by the next user to, for instance, the vehicle 102, and causes a display 422 (described later) of the use management device 400 to display it for presentation to the current user.

It should be noted that the above method of generating a suggestion of changing the return location is merely exemplary and by no means limits the present invention. The type 1 suggestion may be generated by any method capable of generation based on the schedule information generated about the next user irrespective of the schedule information generated about the current user. For instance, based on the schedule information generated about the next user, the suggesting section 326 may locate respective locations of some of a bus stop, a train station, etc. on the traffic line where the next user is supposed to stay for a predetermined period of time in addition to the destination set in the action schedule, and generate a suggestion containing a candidate for the return location in the vicinity of each location.

Meanwhile, the type 2 suggestion may be generated by any method capable of generation based on both of the schedule information generated about the next user and the schedule information generated about the current user. For instance, the suggesting section 326 may locate respective closest locations on two traffic lines of the next user and the current user in a three-dimensional space, which is defined by adding a time axis representing time to a two-dimensional plane representing locations on the map. Based on the located locations on the traffic lines, the suggesting section 326 may search the map for a location of a candidate for the return location within a range reachable for the current user and the next user within a predetermined period of time.

[2.8 Incentive Providing Section 328]

The incentive providing section 328 provides the incentive for agreement on the suggestion of changing the return location to one of the users, except the user 130 (the owner of the vehicle 102), who is the current user. The incentive may be provided as so-called “point”, which for instance, determines the discount rate of a usage fee for the vehicle 102 or determines a grade of a prize to be exchanged as described above. When the current user agrees on the suggestion of changing the return location and terminates the use of the vehicle 102 at the return location according to the agreed suggestion, the incentive providing section 328 provides to the current user a predetermined amount of the incentive, or points, corresponding to the agreed suggestion type. Specifically, the incentive providing section 328 accesses the incentive information contained in the user information of the current user stored in the user DB 352 and increases the held points of the current user indicated by the incentive information by an increment of the predetermined points for update.

Here, the incentive providing section 328 defines the incentive (i.e., points) for agreement on the type 1 suggestion to be larger than the incentive for agreement on the type 2 suggestion. The type 1 suggestion is supposed to be more convenient to the next user independently of the schedule of the current user as compared with the type 2 suggestion. Thus, the incentive defined as described above allows the current user to be encouraged to accept the suggestion that is move convenient to the next user.

[2.9 Charging Section 330]

The charging section 330 calculates a usage fee related to, among the pieces of the use management information stored in the use information DB 354, one provided with the status “TERMINATED”, the usage fee being charged to the corresponding user, except the user 130 (the owner of the vehicle 102). Specifically, the charging section 330 calculates the usage fee based on: the length of the use time of using the vehicle 102 indicated by the use management information; and the held points indicated by the incentive information in the use management information. The charging section 330 then charge the usage fee to the user through, for instance, a known charging system (not shown) using a credit card, etc. Meanwhile, when discounting the usage fee in accordance with the held points, the charging section 330 reduces the held points, which is indicated by the incentive information, by a decrement of the points used for the discount.

[3. Configuration of In-vehicle System 120]

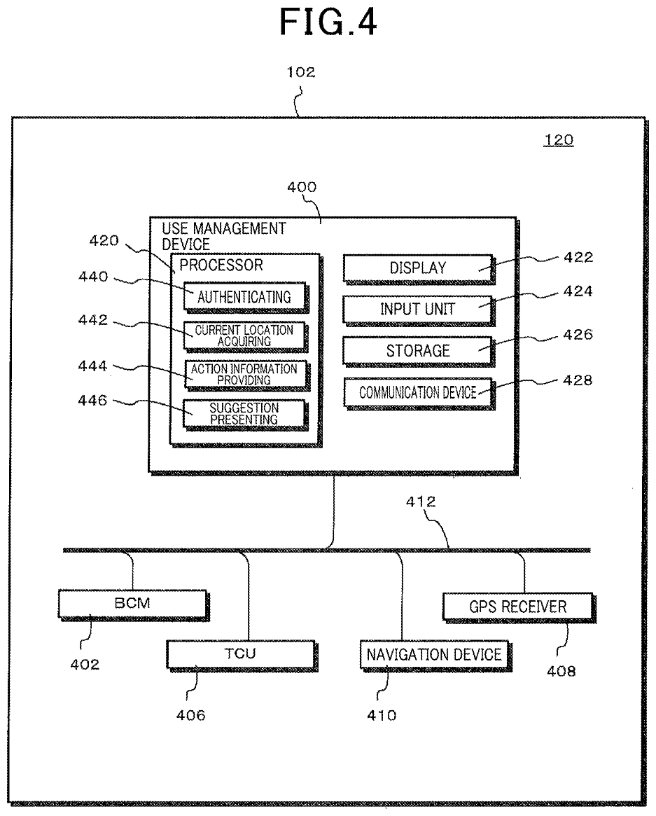

FIG. 4 shows a configuration of the in-vehicle system 120 in the vehicle 102. The in-vehicle system 120 includes the use management device 400 and a BCM (Body Control Module) 402. The in-vehicle system 120 also includes a TCU (Telematics Control Unit) 406, a GPS receiver 408, and the navigation device 410.

The use management device 400, the BCM 402, the TCU 406, the GPS receiver 408, and the navigation device 410 are connected to each other for communication through an in-vehicle network bus 412. Here, the in-vehicle network bus 412 is, for instance, a CAN bus compliant with CAN (Controller Area Network) communication standards.

The TCU 406, which includes a wireless device, communicates with the use management server 106 through the Internet connected to a public line, etc. The GPS receiver 408 receives a GPS radio electric wave from a GPS satellite and outputs current location information of the vehicle 102. The navigation device 410 acquires the current location information from the GPS receiver 408 and displays the acquired current location on a display (not shown) of the navigation device 410 along with the map information. The navigation device 410 also searches for a route to the destination inputted by the current user of the vehicle 102 and displays it on the display.

The BCM 402 and the use management device 400 will be described below.

[3.1 BCM 402]

The BCM 402 controls unlocking of a door of the vehicle 102 and the start/stop of the vehicle 102. In response to receiving a door-unlocking request from the FOB key 160, the BCM 402 authenticates the electronic key of the FOB key 160 and unlocks the door. In addition, in response to a start switch (not shown) of the vehicle 102 being pressed, the BCM 402 authenticates electronic key information, if any, acquired from the nearby FOB key 160 for the start of the vehicle 102.

In addition, in response to receiving a door-unlocking request from the use management device 400, the BCM 402 unlocks the door of the vehicle 102. Meanwhile, when the start switch of the vehicle 102 is pressed but communication with the nearby FOB key 160 is not possible, the BCM 402 sends a start authorization request to the use management device 400. Then, in response to receiving a start authorization notification from the use management device 400, the BCM 402 starts the vehicle 102.

[3.3 Use Management Device 400]

The use management device 400 receives a variety of operation requests sent from the mobile terminal of each user to the vehicle 102, and determines whether the requested operations are to be denied while authenticating the key code contained in the operation requests. In addition, the use management device 400 notifies the start of the use of the vehicle 102 by the user to the use management server 106.

Further, the use management device 400 sends information of the current location, the destination, and the scheduled travel route of the vehicle 102 to the use management server 106. In addition, the use management device 400 presents a suggestion of changing the return location from the use management server 106 to the current user, and sends a selection result by the current user responsive to the suggestion of changing to the use management server 106.

The use management device 400 includes a processor 420, the display 422, an input unit 424, a storage 426, and a communication device 428. The display 422, which is, for instance, a liquid crystal display, displays an image and/or a text as controlled by the processor 420. The input unit 424, which is, for instance, a touch panel provided on a display screen of the display 422, receives instructions, data, etc. inputted from the user and outputs such inputted information to the processor 420. Meanwhile, the communication device 428 is, for instance, a CAN transceiver for communication with the other devices such as the BCM 402 through, for instance, the in-vehicle network bus 412 (CAN bus).

The storage 426 includes, for instance, a volatile or non-volatile semiconductor memory and/or a hard disk device, etc. The storage 426 stores data necessary for processing by the processor 420 in advance or as the processing advances.

The processor 420 is, for instance, a computer including a processor such as CPU. The processor 420 may include a programmed ROM, a RAM for temporarily storing data, etc. The processor 420 also includes, as functional elements or functional units, an authenticating section 440, a current location acquiring section 442, an action information providing section 444, and a suggestion presenting section 446.

Such functional elements of the processor 420 are implemented by, for instance, the execution of a program by the processor 420, or the computer. It should be noted that such a computer program may be stored in any computer-readable storage medium.

The authenticating section 440 receives the electronic key basic information of the user from the use management server 106 at predetermined time intervals, and stores it in the storage 426. Meanwhile, the use management device 400 receives the information of the reservation ID associated with the reserved time range for use related to the terminated use from the use management server 106, and stores it in the storage 426.

Meanwhile, in response to receiving the door-unlocking request, which contains the key code, from the mobile terminal of the user, the authenticating section 440 authenticates the key code. In addition, when the key code passes the authentication, the authenticating section 440 sends the door-unlocking request to the BCM 402 as long as the current time is within the reserved time range for use contained in the key code and the reservation ID contained in the key code is different from the stored reservation ID associated with the terminated use. Simultaneously, if the current unlocking of the door is the first unlocking of the door using this key code, the authenticating section 440 sends the start-of-use notification, which contains the reservation ID contained in this key code, to the use management server 106.

Further, in response to receiving the start authorization request from the BCM 402, the authenticating section 440 acquires a key code from the nearby mobile terminal and authenticates this key code. In addition, when the key code passes the authentication, the authenticating section 440 sends the start authorization notification to the BCM 402 as long as the current time is within the reserved time range for use contained in the key code and the reservation ID contained in the key code is different from the stored reservation ID associated with the terminated use.

The current location acquiring section 442 acquires, in response to the request from the use management server 106, the current location information from the GPS receiver 408 and sends the current location of the vehicle 102 to the use management server 106.

In response to the request from the use management server 106, the action information providing section 444 causes the navigation device 410 to send information such as the location of the currently set destination and information of the travel route according to the currently selected route guide to the use management server 106 as the action schedule information of the current user.

The suggestion presenting section 446 causes the display 422 to display the suggestion list for changing the return location sent from the use management server 106. In addition, when the current user of the vehicle 102 selects a single suggestion from the suggestion list displayed on the display 422 and inputs it through the input unit 424, the suggestion presenting section 446 responsively identifies the selected (inputted) single suggestion and sends information of the identified selected single suggestion to the use management server 106.

In addition, in response to receiving a notification about the single suggestion user agreed on by both the current user and the next user from the use management server 106, the suggestion presenting section 446 causes the display 422 to display a notification indicating the agreement has been reached and the agreed suggestion.

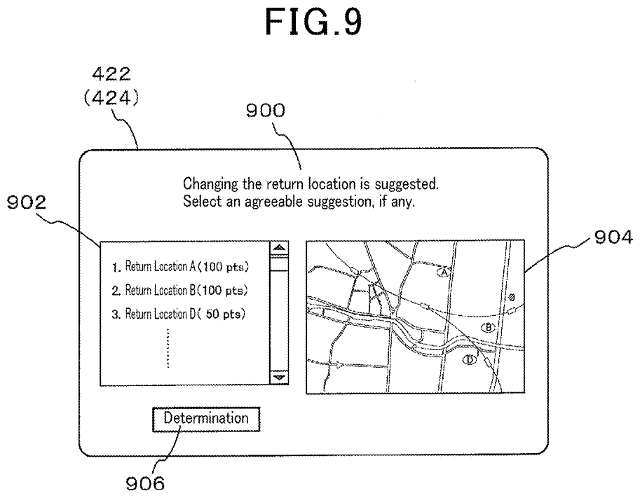

FIG. 9 shows an example of the suggestion list displayed on the display 422 of the in-vehicle system 120. In the example as shown, a message 900 appears on a screen of the display 422 at an upper portion thereof, indicating that changing the return location is suggested. In addition, a text box 902 appearing on the screen at a left portion thereof shows therein a list of suggestions of changing the return location selected by the next user, and an image 904 appearing at the right thereof shows the respective locations of the candidates for the return location, each of which is represented by an oval mark on the map. Here, in each of the rows of the suggestions appearing in the text box 902, an amount of the incentive (in the present embodiment, points) to be provided when the corresponding suggestion is agreed on may be displayed as shown in parentheses in FIG. 9. Alternatively or additionally, in each of the rows of the suggestions appearing in the text box 902, a travel time to the corresponding candidate for the return location from a scheduled spot to be visited by or the current location of the current user may be displayed.

This screen is provided with the input unit 424, or the touch panel, with an overlap. For instance, when the current user of the vehicle 102 touches the row of “Return Location A” in the text box 902, this row is highlighted and, further, a character “A” in the oval corresponding thereto on the map of the image 904 at the right is simultaneously highlighted. After highlighting the row of the agreeable suggestion by touching, the user depresses a determination button 906 at a lower portion of the screen to determine the agreement on the suggestion. The in-vehicle system 120 sends the type 1 or type 2 suggestion selected by the current user for agreement to the use management server 106.

[4. Process by Vehicle Management System 100]

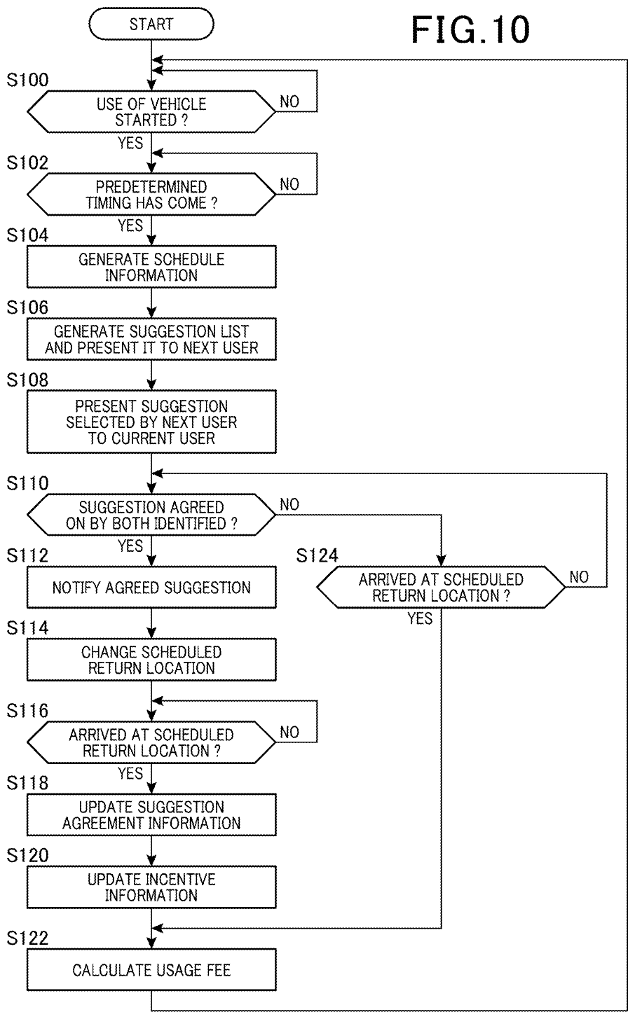

Next, a process being performed by the use management server 106 of the vehicle management system 100 for suggesting changing the return location will be described with reference to a flowchart shown in FIG. 10. This process is started as the use management server 106 is turned on, and terminated as the use management server 106 is turned off.

At the start of the process, the suggesting section 326 of the processor 300 first determines whether the use of the vehicle 102 has been started (S100). The above may be determined by determining whether the notification indicating that the vehicle 102 has started to be used from the use management section 320 is received. When the notification indicating that the vehicle 102 has started to be used is received from the use management section 320, the suggesting section 326 determines the vehicle 102 to have started to be used.

When the vehicle 102 is determined not to have started to be used (S100, NO), the suggesting section 326 returns to Step S100, waiting for the start of use. Meanwhile, when the vehicle 102 is determined to have started to be used (S100, YES), the suggesting section 326 determines, regarding the started use, whether the predetermined timing for suggesting changing the return location has come (S102). When the predetermined timing is determined not to have come (S102, NO), the suggesting section 326 returns to Step S102, waiting for the predetermined timing to come.

Meanwhile, when the predetermined timing is determined to have come (S102, YES), the suggesting section 326 generates schedule information of each of the current user and the next user of the vehicle 102 (S104), and generates a suggestion list containing suggestions based on the generated schedule information and presents it first to the next user (S106). Specifically, the suggesting section 326 sends the suggestion list to the mobile terminal of the next user.

Subsequently, the suggesting section 326 acquires the suggestions selected by the next user through the mobile terminal of the next user, and presents a list of the acquired suggestions to the current user (S108). Specifically, the suggesting section 326 sends the list of the suggestions to the vehicle 102 and causes the display 422 to display it.

The suggesting section 326 then determines whether one of the suggestions selected by the current user is received from the vehicle 102, that is, whether one of the suggestions agreed on by both the current user and the second user is identified (S110). When the single suggestion is determined to be identified (S110, YES), the suggesting section 326 sends the identified agreed suggestion to the vehicle 102 and the mobile terminal of the next user for notification (S112). In addition, the suggesting section 326 changes the scheduled return location, which is contained in the use management information of the current use, to the return location indicated by the agreed suggestion (S114).

Next, the suggesting section 326 determines whether the vehicle 102 has arrived at the changed scheduled return location (S116). When the vehicle 102 is determined not to have arrived (S116, NO), the suggesting section 326 returns to Step S116, waiting for the arrival.

Meanwhile, when the vehicle 102 is determined to have arrived at the scheduled return location (S116, YES), the suggesting section 326 accesses the use information DB 354 in response to, for instance, receiving a notification indicating that the current use of the vehicle 102 has been terminated from the use management section 320, and stores a value representing the type of the agreed suggestion in the suggestion agreement information in the use management information related to the terminated use, thereby updating the suggestion agreement information (S118).

Subsequently, when the user related to the terminated use is not the user 130 (the owner of the vehicle 102), the incentive providing section 328 accesses the use information DB 354 referring to the stored type of the suggestion, and calculates the amount of the incentive (points) for the terminated use. The incentive providing section 328 then adds the calculated points to the held points indicated by the incentive information of the user related to the terminated use, thereby updating the incentive information (S120).

In addition, when the user related to the terminated use is not the user 130 (the owner of the vehicle 102), the charging section 330 accesses the use information DB 354 referring to the use management information related to the terminated use, and calculates a usage fee based on the length of the reserved time range for use contained in the use management information and the held points indicated by the incentive information (S120). In this regard, when a part or all of the held points indicated by the incentive information are used for the discount of the usage fee, the charging section 330 reduces the held points by a decrement of the points for the discount, thereby updating the incentive information. It should be noted that the calculated usage fee is charged to the user and paid by the user through a conventional technology.

After the calculation of the usage fee in Step S122, the processor 300 returns to Step S100, repeating the process.

Meanwhile, when no single suggestion agreed on by both of the current user and the next user is identified in Step S110 (S110, NO), that is, when no single suggestion selected by the current user is received from the vehicle 102, the suggesting section 326 determines whether the vehicle 102 has arrived at the scheduled return location currently stored in the corresponding use management information (S124). When it is determined not to have arrived (S124, NO), the suggesting section 326 returns to Step S110, repeating the process. Meanwhile, when the vehicle 102 is determined to have arrived at the scheduled return location currently stored in the use management information (S124, YES), the suggesting section 326 waits for receiving a notification indicating the termination of the current use of the vehicle 102 from the use management section 320, advancing to the process to Step S122.

[5. Summary]

As described above, the vehicle management system 100 according to the present embodiment manages a vehicle that is to be used by a plurality of users. The vehicle management system 100 includes the use management section 320 that manages the schedule-of-use information and the status of the use of the vehicle 102, the action schedule acquiring section 324 that acquires the action schedule of the user, and the suggesting section 326 that suggests changing the return location (parking location) of the vehicle 102 at the termination of the use of the vehicle 102 to the next user who uses the vehicle 102 next after the current user. The suggesting section 326 generates the schedule information of the next user who uses the vehicle 102 next after the current user based on the action schedule of the next user, and outputs the type 1 suggestion (first suggestion) based on the generated schedule information of the next user.

Such a configuration allows a location convenient to the next user to be suggested to the next user as a location to be changed for the return location of the vehicle 102 for the current user, i.e., the start-of-use location for the next user, allowing the next user to select from such suggestions those actually convenient to himself/herself. Thus, the vehicle management system 100 allows for leading the return location of the vehicle 102 for the current user to be changed to a location truly convenient to the next user.

In addition, the suggesting section 326 of the vehicle management system 100 outputs to the current user the first suggestion of changing the return location for the current user. Such a configuration allows for encouraging the current user to change the return location of the vehicle 102 to another return location convenient to the next user, thereby enhancing the convenience to the next user.

In addition, for the vehicle management system 100, the schedule information of the next user contains the current location of the next user, the information of a location of a scheduled spot to be visited during the period from the current time to the scheduled start-of-use time for the start of the use of the vehicle 102, or the information of a location of a spot to be visited during the use of the vehicle 102 started from the scheduled start-of-use time.

Such a configuration allows for effectively selecting and suggesting a candidate for the return location for the current user that is convenient to the next user.

In addition, the suggesting section 326 of the vehicle management system 100 presents the suggestion of changing the return location for the current user to the next user, and acquires ones selected by the next user from among the presented suggestions. The suggesting section 326 then presents the suggestions selected by the next user to the current user.

Such a configuration allows for achieving agreement on a change in the return location in favor of the preference of the next user, enhancing the convenience to the next user.

In addition, the suggesting section 326 of the vehicle management system 100 also generates the schedule information of the current user based on the action schedule of the current user, and outputs the type 2 suggestion (second suggestion) based on both of the generated schedule information of the current user and the schedule information of the next user.

Such a configuration allows for enhancing the convenience to the next user also in consideration of the convenience to the current user.

In addition, in the vehicle management system 100, the schedule information of the current user contains, about the current user, the current destination, the information of a location of scheduled spots to be visited or a scheduled travel route during the period from the current time to the scheduled termination-of-use time for terminating the use of the vehicle 102, or the information of a location of scheduled spots to be visited during the predetermined period of time after the scheduled termination-of-use time. Such a configuration allows for effectively taking the convenience to the current user into consideration.

In addition, the vehicle management system 100 includes the incentive providing section 328 that provides the incentive for the agreement on the type 1 suggestion (first suggestion) to the user. Such a configuration allows for motivating the user to accept the suggestion in using the vehicle 102, effectively encouraging him/her to agree on changing the return location.

In addition, the incentive providing section 328 of the vehicle management system 100 also provides the incentive for the agreement on the type 2 suggestion (second suggestion) to the user. The incentive providing section 328 defines the incentive for the agreement on the type 1 suggestion (first suggestion) to be larger than the incentive for the agreement on the type 2 suggestion (second suggestion). Such a configuration allows for effectively encouraging the user to agree on the type 1 suggestion, which is more convenient to the next user.

[6. Modifications]

It should be noted that the present invention is by no means limited to the configurations according to the present embodiment but may be implemented in a variety of aspects without departing from the scope of the present invention.

For instance, according to the present embodiment, the vehicle management system 100 exemplarily suggests changing the return location in using the single vehicle 102 but the present invention is not limited thereto. The vehicle management system 100 may manage a plurality of vehicles that are to be used by a plurality of users. In this case, the same process for the use of the vehicle 102 may be performed for each of the plurality of vehicles.

In addition, according to the present embodiment, the respective predetermined amounts of incentive, which are defined in advance per type, are provided for the agreement on the type 1 suggestion and the agreement on the type 2 suggestion, but the present invention is not limited thereto. For instance, the incentive to be provided for each of the type 1 and type 2 suggestion may vary in accordance with a distance between the changed return location and the scheduled travel route of the current user (e.g., the amount being increased with an increase in the distance).

In addition, according to the present embodiment, the next user merely selects some from among the suggestions presented by the use management server 106, but the present invention is not limited thereto. For instance, in selecting, the next user may rank the selected suggestions (e.g., ranking in preference order). This allows the current user to select the suggestions in consideration of the preference of the next user shown by the ranking. Further, in this case, an amount of the incentive (points) defined in accordance with the rank of the agreed suggestion may be provided to the current user by the incentive providing section 328.

In addition, according to the present embodiment, the use management server 106 includes the suggesting section 326, but the present invention is not limited thereto. A part of functional elements, which includes the suggesting section 326, of the use management server 106 may be provided to the use management device 400 of the in-vehicle system 120.

In addition, according to the present embodiment, the use management device 400 is an in-vehicle device connected to another device through the in-vehicle network bus 412, but the present invention is not limited thereto. For instance, the use management device 400 may be implemented in the mobile terminal of the current user. In this case, the same functional element as the use management device 400 or a functional element similar thereto may be implemented by executing a dedicated application program in the mobile terminal, the functional element being activated by connecting the mobile terminal to another in-vehicle device by wire or wirelessly.

Alternatively, a part of the functional elements of the use management device 400 may be implemented in the mobile terminal of the user. For instance, the suggestion presenting section 446 may be implemented in the mobile terminal of the user, causing a list of suggestions of changing the return location sent from the use management server 106 to be displayed on the mobile terminal and causing selection of the suggestions by the user to be sent from the mobile terminal to the use management server 106.

### REFERENCE SIGN LIST

100 . . . vehicle management system, 102 . . . vehicle, 104 . . . network, 106 . . . use management server, 120 . . . in-vehicle system, 130, 132, 134 . . . user, 140, 142, 144 . . . mobile terminal, 150, 152, 154 . . . electronic key (key code), 160 . . . FOB key, 300, 420 . . . processor, 302, 426 . . . storage, 304, 428 . . . communication device, 320 . . . use management section, 322 . . . electronic key issuing section, 324 . . . action schedule acquiring section, 326 . . . suggesting section, 328 . . . incentive providing section, 330 . . . charging section, 350 . . . map information, 352 . . . user DB, 354 . . . use information DB, 356 . . . schedule DB, 400 . . . use management device, 402 . . . BCM (Body Control Module), 406 . . . TCU (Telematics Control Unit), 408 . . . GPS receiver, 410 . . . navigation device, 412 . . . in-vehicle network bus, 422 . . . display, 424 . . . input unit, 440 . . . authenticating section, 442 . . . current location acquiring section, 444 . . . action information providing section, 446 . . . suggestion presenting section

What is claimed is:

1. A vehicle management system that manages a vehicle that is to be used by a plurality of users, the vehicle management system comprising:
a use management section that manages schedule-of-use information and a state of use of the vehicle;
an action schedule acquiring section that acquires an action schedule of each of the plurality of users; and
a suggesting section that outputs a suggestion of changing a return location, or a parking location, of the vehicle at termination of use of the vehicle to, among the plurality of users, a next user who uses the vehicle next after a current user, the suggesting section generating schedule information of the next user based on the action schedule of the next user, and outputting the suggestion based on the generated schedule information of the next user, the suggestion being referred to as a first suggestion.

2. A vehicle management system that manages a vehicle that is to be used by a plurality of users, the vehicle management system comprising:
a use management section that manages schedule-of-use information and a state of use of the vehicle;
an action schedule acquiring section that acquires an action schedule of each of the plurality of users; and
a suggesting section that outputs a suggestion of changing a return location, or a parking location, of the vehicle at termination of the use of the vehicle to, among the plurality of users, a current user who currently uses the vehicle, the suggesting section generating schedule information of, among the plurality of users, a next user who uses the vehicle next after the current user based on the action schedule of the next user, and outputting the suggestion based on the generated schedule information of the next user, the suggestion being referred to as a first suggestion.

3. The vehicle management system according to claim 2, wherein the schedule information of the next user comprises: a current location of the next user; information of a location of a scheduled spot to be visited during a period from a current time to a scheduled start-of-use time for start of the use of the vehicle; or information of a location of a spot to be visited during the use of the vehicle started from the scheduled start-of-use time.

4. The vehicle management system according to claim 2, wherein the suggesting section:
presents the suggestion to the next user;
acquires the suggestion selected from the presented suggestion by the next user; and
presents the suggestion selected by the next user to the current user.

5. The vehicle management system according to claim 2, wherein
the suggesting section further generates schedule information of the current user based on the action schedule of the current user, and outputs the suggestion based on both of the generated schedule information of the current user and the schedule information of the next user, the suggestion being referred to as a second suggestion.

6. The vehicle management system according to claim 5, wherein the schedule information of the current user comprises, about the current user: a current destination; information of a location of a scheduled spot to be visited or a scheduled travel route during a period from a current time to a scheduled termination-of-use time for termination of the use of the vehicle; or information of a location of a scheduled spot to be visited during a predetermined period of time after the scheduled termination-of-use time.

7. The vehicle management system according to claim 2, further comprising an incentive providing section that provides an incentive for agreement on the first suggestion to the current user.

8. The vehicle management system according to claim 5, further comprising an incentive providing section that provides to the current user an incentive for agreement on each of the first suggestion and the second suggestion, the incentive provided by the incentive providing section for the agreement on the first suggestion being larger than the incentive for the agreement on the second suggestion.
